(19) United States
(12) Patent Application Publication
(10) Pub. No.: US 2024/0419002 A1
(43) Pub. Date: Dec. 19, 2024

(54) Lens Mounting Systems

(71) Applicant: Apple Inc., Cupertino, CA (US)

(72) Inventors: Ivan S Maric, Campbell, CA (US); Blake N Trekell, San Francisco, CA (US)

(21) Appl. No.: 18/335,061

(22) Filed: Jun. 14, 2023

(51) Int. Cl. G02B 27/01; G02B 7/14

(52) U.S. Cl. CPC G02B 27/0176; G02B 7/14; G02B 27/0172

(57) ABSTRACT

A head-mounted device may include optical assemblies for presenting images to a user. Each optical assembly may have a support, a fixed lens mounted to the support, and a display configured to provide an image to an eye box through the fixed lens. Removable vision correction lenses may be used to correct for user vision defects such as nearsightedness. The vision correction lenses may be removably coupled to the optical assemblies. When coupled to the optical assemblies, the vision correction lenses overlap the fixed lenses. Each removable vision correction lens and corresponding optical assembly may have structures such as kinematic mount alignment protrusions and recesses configured to form a kinematic coupling. Debris mitigation features may be provided such as alignment structure debris covers, debris collection grooves, magnets for attracting debris, adhesive for gathering debris, and liquid drainage holes to facilitate washing to remove debris.

### FIELD

This relates generally to electronic devices, and, more particularly, to electronic devices such as head-mounted devices.

### BACKGROUND

Electronic devices have components such as displays and lenses. If care is not taken, debris contamination can interfere with the operation of such devices.

### SUMMARY

A head-mounted device may include optical assemblies for presenting images to a user. Each optical assembly may have a support, a fixed lens mounted to the support, and a display configured to provide an image to an eye box through the fixed lens.

Removable vision correction lenses may be used to correct for user vision defects such as nearsightedness. The vision correction lenses may be removably coupled to the optical assemblies using magnets, snap connectors, or other connection mechanisms. When coupled to the optical assemblies, the vision correction lenses overlap the fixed lenses.

Each removable vision correction lens and corresponding optical assembly may have structures such as kinematic mount alignment protrusions and recesses configured to form a kinematic coupling. The kinematic couplings may be used to align the removable vision correction lenses with respect to the optical assemblies.

Debris (dust) mitigation features may be provided such as kinematic mount alignment structure debris covers, debris collection grooves, magnets for attracting debris, adhesive for gathering debris, and liquid drainage holes (wash holes) to facilitate washing to remove debris. The debris mitigation features may help ensure that the removable lenses can be aligned to the optical assemblies accurately using the kinematic couplings.

### BRIEF DESCRIPTION OF THE DRAWINGS

FIG. 1 is a diagram of an illustrative head-mounted device in accordance with an embodiment.

FIG. 2 is a rear view of an illustrative removable vision correction lens in accordance with an embodiment.

FIG. 3 is a side view of illustrative kinematic mount alignment structures including a kinematic mount alignment protrusion and a corresponding kinematic mount alignment recess in accordance with an embodiment.

FIG. 4 is a diagram of an illustrative optical assembly with a kinematic mount alignment recess and a vision correction lens with a mating kinematic mount alignment protrusion in accordance with an embodiment.

FIG. 5 is a diagram of an illustrative optical assembly with a kinematic mount alignment protrusion and a vision correction lens with a mating kinematic mount alignment recess in accordance with an embodiment.

FIGS. 6, 7, 8, 9, and 10 are cross-sectional side views of illustrative kinematic mounting features on various portions of optical assemblies and vision correction lenses in accordance with an embodiment.

FIG. 11 is a cross-sectional side view of illustrative kinematic mount alignment structures for a kinematic mount coupling in accordance with an embodiment.

FIGS. 12, 13, 14, and 15 are perspective views of illustrative kinematic mount alignment structures in accordance with embodiments.

FIG. 16 is a cross-sectional side view of an illustrative kinematic mount alignment recess with a dust cover based on a moving wiper in accordance with an embodiment.

FIG. 17 is a cross-sectional side view of an illustrative kinematic mount alignment recess with a dust cover (wiper) based on multiple moving wiper blades in accordance with an embodiment.

FIG. 18 is a top view of an illustrative kinematic mount alignment dust cover with slits to allow portions of the dust cover to be pushed aside when a kinematic mount alignment protrusion is pressed against the dust cover and received within an alignment recess that is covered by the dust cover in accordance with an embodiment.

FIG. 19 is a cross-sectional side view of the illustrative kinematic mount alignment dust cover arrangement of FIG. 18 in accordance with an embodiment.

FIGS. 20 and 21 are cross-sectional side views of illustrative kinematic mount alignment structures with dust mitigation features in accordance with embodiments.

FIG. 22 is a perspective view of an illustrative dust accumulation groove and associated kinematic mount alignment recess in accordance with an embodiment.

FIG. 23 is a cross-sectional side view of an illustrative optical assembly configured to receive a removable lens and configured to receive a removable dust cover in accordance with embodiments.

### DETAILED DESCRIPTION

Electronic devices such as head-mounted devices may be exposed to debris (e.g., small particles, sometimes referred to as dust). Debris mitigation features, which may sometimes be referred to as dust mitigation features, may be incorporated into head-mounted devices to help ensure that the head-mounted devices operate satisfactorily. In an illustrative configuration, a head-mounted device may be provided with removable vision correction lenses. These lenses may be used to compensate for nearsightedness, farsightedness, astigmatism, and/or other vision defects of users. To align the removable lenses with the portions of the electronic devices to which the removable lenses are attached, the removable lenses and electronic devices may be provided with mating kinematic mount coupling features. Debris (dust) mitigation techniques may be used to help ensure that the kinematic mount coupling features are not adversely affected by the presence of debris (e.g., dust particles such as metallic particles, hair, etc.).

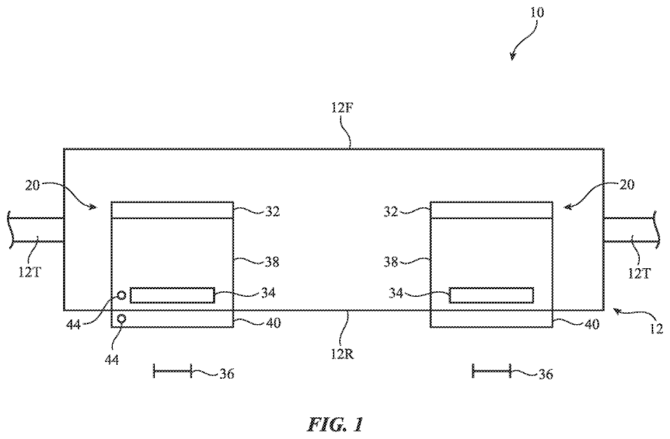

FIG. 1 is a schematic diagram of an illustrative electronic device of the type that may use removable lenses. Device 10 of FIG. 1 may be a head-mounted device (e.g., goggles, glasses, a helmet, and/or other head-mounted device). In an illustrative configuration, device 10 is a head-mounted device such as a pair of goggles (sometimes referred to as virtual reality goggles, mixed reality goggles, augmented reality glasses, etc.).

As shown in the illustrative cross-sectional top view of device 10 of FIG. 1, device 10 may have a housing such as housing 12 (sometimes referred to as a head-mounted support structure, head-mounted housing, or head-mounted support). Housing 12 may include a front portion such as front portion 12F and a rear portion such as rear portion 12R. When device 10 is worn on the head of a user, rear portion 12R rests against the face of the user.

Head-mounted housing 12 may be attached to side portions 12T (e.g., a strap, glasses temples in a pair of glasses, and/or other structures for helping to mount housing 12 on a head of a user). When housing 12 is being worn on the head of a user, the front of housing 12 may face outwardly away from the user and rear portion 12R of housing 12 may face towards the user. In this configuration, rear portion 12R may face the user's eyes located in eye boxes 36. Device 10 may have electrical and optical components that are used in displaying images to eye boxes 36 when device 10 is being worn. These components may include left and right optical assemblies 20 (sometimes referred to as optical modules). Each optical assembly 20 may have an optical assembly support 38 (sometimes referred to as a lens barrel, optical module support, or support structure).

Each assembly 20 may have a display 32 that has an array of pixels for displaying images and a lens 34 (sometimes referred to as the fixed lens, main lens, or built-in lens of assembly 20 and device 10). Lens 34 may include one or more lens elements formed from optically clear polymer or other transparent material such as glass. Removable vision correction lenses 40 may be provided for correcting user vision defects (e.g., refractive errors such as nearsightedness, farsightedness, and/or astigmatism). In each assembly 20, display 32 and lens 34 may be coupled to and supported by support 38. Magnets 44 or other attachment mechanisms (e.g., snap connectors or other connection mechanisms) may be used to removably mount vision correction lenses 40 to optical assemblies 20 in alignment with lenses 34. For example, assemblies 20 and lenses 40 may be provided with a corresponding rings of mating magnets 44 (not shown in all of the drawings herein). During operation, images displayed by displays 32 may be presented to eye boxes 36 through lenses 34 and corrective lenses 40 for viewing by the user.

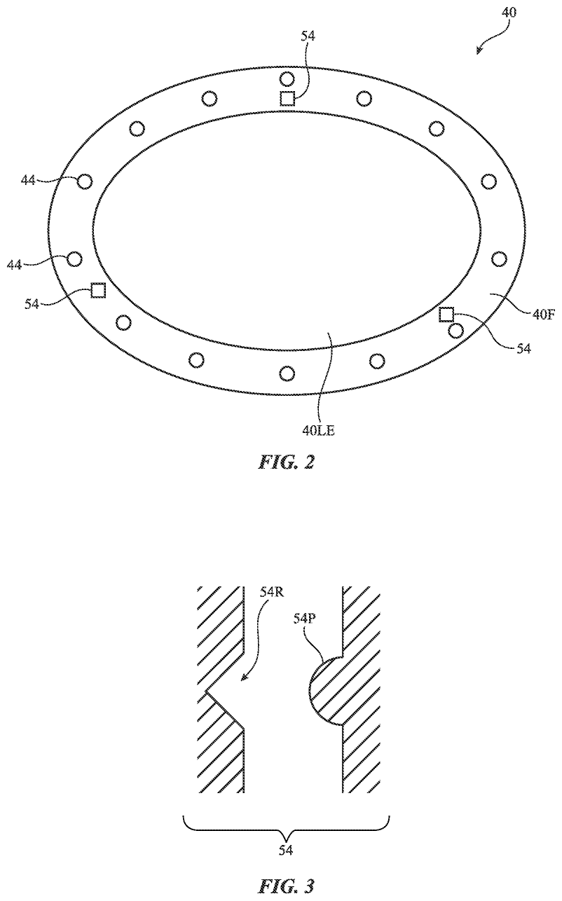

FIG. 2 is a rear view of an illustrative removable vision correction lens. As shown in FIG. 2, removable vision correction lens 40 may have a support structure (sometimes referred to as a frame structure, support, lens support, etc.) such as removable vision correction lens frame 40F. Vision correction lens element 40LE may be attached to frame 40F. Lens element 40LE may have a circular shape, an oval shape, a teardrop shape, or other suitable shape. Frame 40F may run around the periphery of lens element 40LE. In an illustrative configuration, lens element 40LE is formed from transparent polymer or glass (e.g., an optically clear polymer) and frame 40F is formed from an opaque polymer (e.g., a durable polymer that can withstand the wear associated with repeated attachments and removals of lens 40) or other opaque material (e.g., metal). Configurations in which these structures are formed from other materials and/or combinations of one or more of these materials may also be used.

It may be desirable to accurately mount each removable lens 40 relative to its corresponding fixed lens 34. To accurately constrain the position of lens 40 relative to lens 34 (e.g., to constrain six degrees of freedom for lens 40), a kinematic mounting system may be used that has a set of kinematic mount alignment structures 54. As shown in FIG. 2, for example, a set of three kinematic mount alignment structures 54 may be used that are spaced at approximately equidistant locations around the periphery of lens 40. Structures 54 may include protrusions and mating recesses with surfaces that help establish contact points for alignment. When lenses 40 are magnetically attached to lenses 34, the mating surfaces of structures 54 establish a set of contact points that set the desired location of each lens 40 relative to each associated lens 34 (preferably without over-constraining). In an illustrative example, an optical assembly 20 has three radially extending V-shaped recesses and a corresponding lens 40 has three hemispherical protrusions that protrude into the V-shaped recesses. This arrangement fixes all six degrees of freedom and forms a kinematic coupling between lens 40 and assembly 20 (and therefore lens 34).

FIG. 3 is a cross-sectional side view of an illustrative kinematic mount alignment structure(s) (sometimes referred to as a kinematic mount coupling structure(s), alignment structure(s), kinematic mounting structure(s), kinematic mount, kinematic coupling, kinematic mount coupling element(s), etc.). As shown in FIG. 3, alignment structure 54 may have a kinematic mount alignment protrusion such as kinematic mount alignment protrusion 54P (sometimes referred to as an alignment protrusion, kinematic protrusion, kinematic coupling protrusion, kinematic coupling structure, kinematic coupling feature, etc.) and a corresponding mating alignment structure such as kinematic mount alignment recess 54R (sometimes referred to as an alignment recess, alignment coupling recess, kinematic mount recess, kinematic coupling structure, kinematic coupling features, etc.). Recess 54R may be formed in a portion of lens 40 or a portion of assembly 20. Similarly, protrusion 54P may be formed from a portion of lens 40 or a portion of assembly 20. In some configurations, which may be illustrated herein as examples, protrusions 54P are formed on lens 40 and recesses are formed in assembly 20.

Protrusion 54P may have any suitable shape (e.g., a spherical shape, a pyramidal shape, a conical shape, a cylindrical shape, etc.). In an illustrative configuration, which may sometimes be described herein as an example, protrusions 54P have spherical (e.g., hemispherical) surfaces and shapes. Recess 54R may be a conical recess, a V-shaped recess (sometimes referred to as a vee, V-groove, V-shaped groove, or vee groove), a pyramidal recess, a conical recess, and/or other recess. Different types of kinematic alignment structures 54 may be used at different locations around lens 40 (and lens 34). For example, in an arrangement in which there are three alignment structures 54 each of which is located at a different one of the three locations of FIG. 2, two of the alignment structures 54 may have V-shaped recesses (e.g., one that extends radially and one that extends along frame 40F) that mate with hemispherical protrusions and one of the alignment structures 54 may be formed by a planar surface that contacts a corresponding hemispherical protrusion. Other kinematic coupling arrangements may be used in mounting lens 40 to assembly 20 and lens 34 if desired.

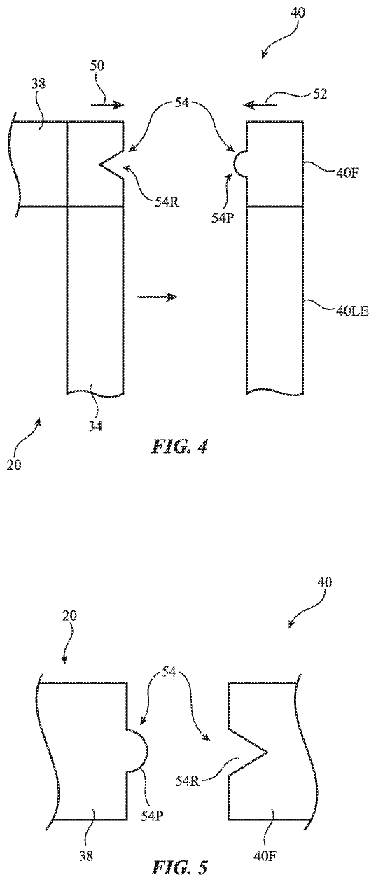

As shown in the cross-sectional side view of FIG. 4, alignment structures 54 may be formed in frame 40F of lens 40 and in support 38 of assembly 20. In the example of FIG. 4, structures 54 include protrusion 54P, which is formed from a portion of frame 40F, and recess 54R, which is formed from a portion of support 38. Protrusion 54P is received within recess 54R and helps align lens 40 to assembly 20 when lens 40 is coupled to assembly 20 by moving lens 40 in direction 52 and/or by moving assembly 20 in direction 50.

If desired, assembly 20 may have one or more alignment protrusions and lens 40 may have corresponding alignment recesses. As shown in the cross-sectional side view of FIG. 5, for example, protrusion 54P may be formed in structure 38 of assembly 20 and mating recess 54R may be formed in frame 40F of lens 40.

FIGS. 6, 7, 8, 9, and 10 are additional cross-sectional side views of illustrative alignment structure arrangements.

In the example of FIG. 6, mating alignment structures 54 have been formed on lens 40 and assembly 20, respectively. As shown in FIG. 6, assembly 40 may have support 38 with an alignment structure 54 and frame 40F of lens 40 may have a mating alignment structure 54. Frame 40F may be attached to lens element 40LE using attachment mechanism 58 (e.g., adhesive, snap structures, a press-fit connection, an overmolding arrangement in which polymer frame material is overmolded onto the peripheral edge of an optical polymer forming lens element 40LE, etc.). By using alignment structures 54, lens element 40LE of lens 40 may be aligned to lens 34 of assembly 20.

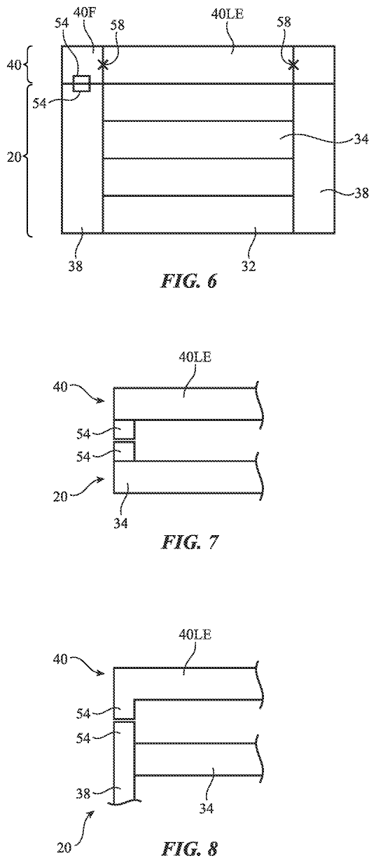

In the example of FIG. 7, alignment structures 54 have been formed from insert-molded parts. With this type of arrangement, polymer forming lenses 40LE and 34 may be molded to alignment structures 54, which may be, for example, metal alignment structures (e.g., metal rings, metal posts, etc.) or other alignment structures that are insert-molded into lenses 40LE and 34.

In the example of FIG. 8, a first alignment structure 54 has been formed as an integral portion of lens element 40LE and a mating second alignment structure 54 has been formed from a portion of support 38.

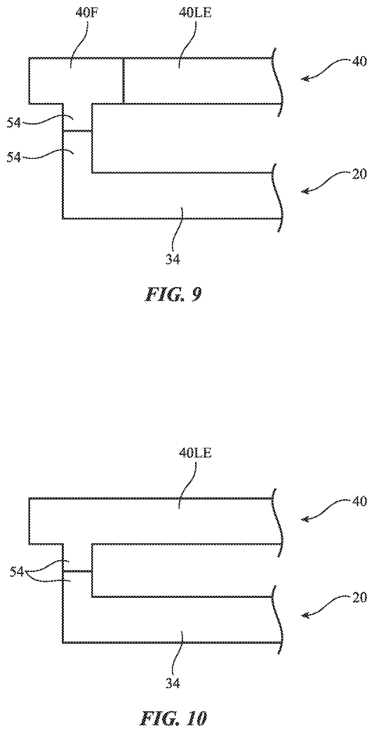

In the example of FIG. 9, a first alignment structure 54 has been formed from a portion of frame 40F of lens 40 and a second alignment structure 54 that mates with the first alignment structure has been formed from an integral portion of lens 34 of assembly 20.

FIG. 10 shows an illustrative configuration in which a first alignment structure 54 has been formed from an integral portion of lens element 40LE of lens 40 and a mating second alignment structure 54 has been formed from an integral portion of lens 34 of assembly 20. Other arrangements may be used, if desired.

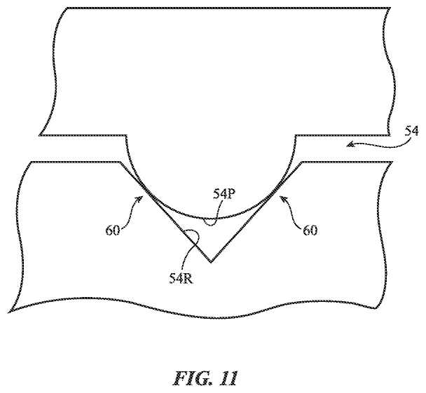

As shown in FIG. 11, when alignment protrusion 54P is received within alignment recess 54P, the surfaces of these mating alignment structures 54 form datum surfaces that align lens 40 and assembly 20. Satisfactory alignment accuracy may be achieved by reducing or eliminating debris such as dust between mating alignment surfaces.

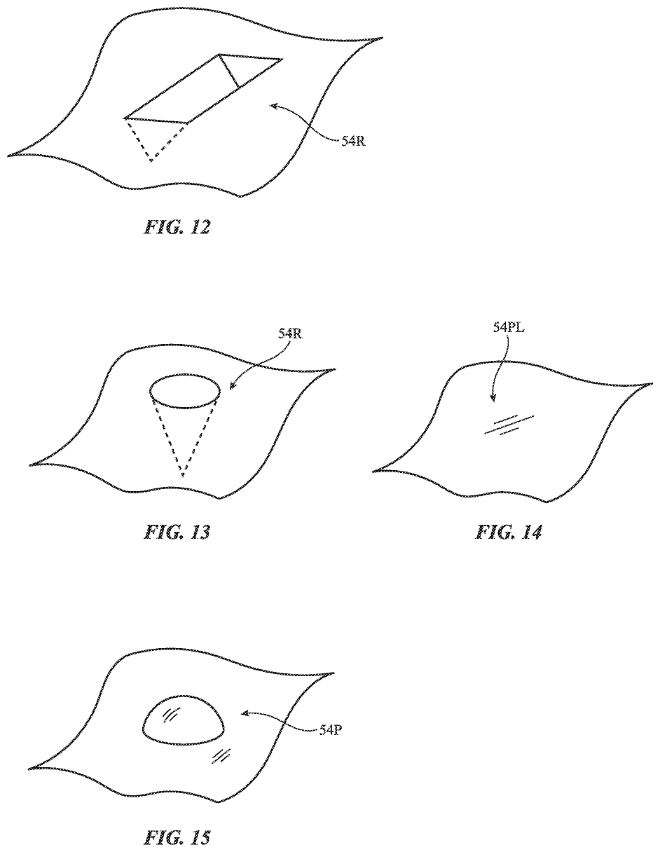

In general, alignment protrusions and recesses may have any suitable shapes, provided that the set of alignment structures 54 that are used for lens 40 and assembly 20 constrain the relative motion between lens 40 and assembly 20 as desired. FIGS. 12, 13, 14, and 15 are perspective views of illustrative alignment structures. Other types of alignment structures may be used, if desired. In the example of FIG. 12, illustrative alignment recess 54R is a V-shaped groove. In the example of FIG. 13, alignment recess 54R is a conical recess. In the example of FIG. 14, alignment structure 54PL is a planar surface. When mated with an alignment protrusion, the planar surface of FIG. 14 may be used to constrain one degree of freedom. In the example of FIG. 15, alignment protrusion 54P has a spherical (e.g., hemispherical) shape.

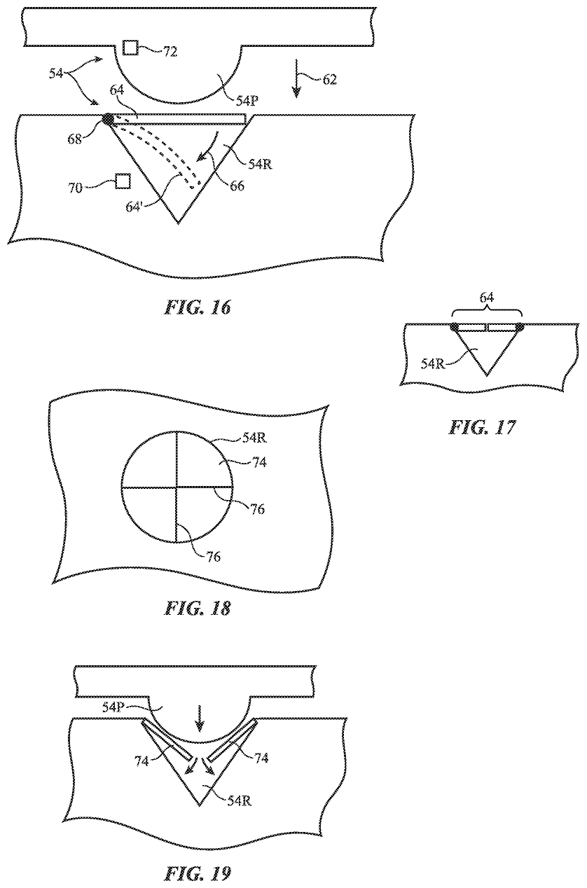

FIG. 16 shows how debris blocking structures (dust blocking structures) may be incorporated into alignment structures 54 to help prevent debris (sometimes referred to as dust) from interfering with the alignment accuracy achieved using structures 54. As shown in FIG. 16, alignment protrusion 54P may be received within mating alignment recess 54R when moved in direction 62. To help prevent debris from entering recess 54R, recess 54R may be provided with a debris cover (sometimes referred to as a dust cover) such as wiper 64. Wiper 64 may be formed from a flexible polymer, metal, or other material that can be deflected about hinge portion 68 when contacted by protrusion 54P (e.g., when lens 40 is mounted to assembly 20 and protrusion 54P is received within recess 54R). When protrusion 54P is not present in recess 54P, wiper 64 may rest in a first position in which wiper 64 covers the opening to recess 54R. During the deflection process, wiper 64 may move in direction 66 to a position in which wiper 64 no longer covers the opening of recess 54R, as shown by illustrative wiper position 64′. During wiper deflection, portions of wiper 64 may wipe clean the side surfaces of recess 54R, thereby helping to mitigate debris contamination. If desired, wiper 64 may be formed from a magnetic material (e.g., a ferromagnetic material such as a ferromagnetic metal that is magnetically attracted to magnets). One or more magnets may be provided to attract wiper 64 and thereby facilitate movement of wiper 64 in desired directions. As an example, a first magnet such as magnet 70 may optionally be mounted to the structure in which recess 54R is formed (e.g., lens 40 or assembly 20) to help deflect wiper 64 downwards into recess 54R and/or a second magnet such as magnet 72 may be optionally be mounted to the structure in which protrusion 54P is formed (e.g., lens 40 or assembly 20) to help pull wiper 64 out of recess 54R and thereby return wiper 64 to its desired position when alignment structures 54P and 54R are not mated to each other.

As shown in FIG. 17, wiper 64 may, if desired, have first and second portions (e.g., blades) that flex inwardly into recess 54R from opposing sides of recess 54R.

FIG. 18 is a top view of an illustrative alignment recess with a kinematic mount alignment recess debris cover (kinematic mount alignment recess dust cover) that has slits. Alignment recess 54R of FIG. 18 has a circular outline. Debris cover 74 may be formed from a flexible polymer or other material. Debris cover 74 may be affixed to the circular peripheral edge of recess 54R and may be provided with slits such as slits 76. Slits 76 divide cover 74 into four pie-shaped sections, each of which may be bent inwardly when a mating alignment protrusion 54P (e.g., a spherical alignment protrusion) is received within recess 54R, as shown in FIG. 19.

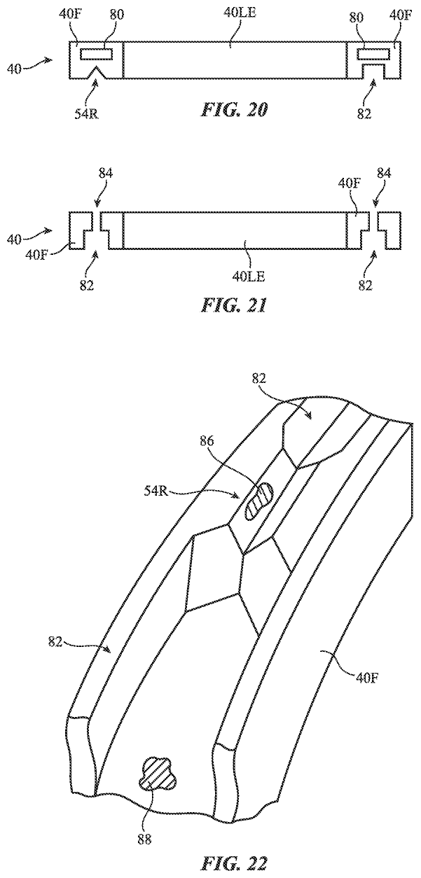

If desired, magnets may be incorporated into lens 40 and/or assembly 20 to help pull debris particles away from alignment surfaces in alignment structures 54. FIG. 20 is a cross-sectional side view of an illustrative lens with such magnets (magnets 80). Portions of lens 40 (e.g., portions of frame 40F in the example of FIG. 20) may be provided with debris gathering recesses such as groove 82. Groove 82 may serve to collect debris (dust) and thereby help prevent the collected debris from contaminating alignment recess 54R.

If desired, a user may wash debris from lens 40 and/or assembly 20. As shown in FIG. 21, liquid (water) drainage holes such as holes 84 may be provided to facilitate the removal of water or other liquid from groove(s) 82 during washing.

FIG. 22 is a perspective view of an illustrative portion of lens 40 (frame 40F) that has been provided with an alignment structure such as recess 54R and a debris removal groove such as groove 82 that is in communication with and therefore contiguous with recess 54R. In this type of arrangement, groove 82 runs along most or all of the periphery of frame 40F, except where interrupted by narrowed portions that form recesses such as recess 54R. Groove 82 may be wider and deeper than recess 54R. If desired, alignment structures 54 such as recess 54R may be provided with coatings such as coating 86. Coating 86, which may cover some or all of the exposed surfaces of recess 54R may help prevent debris from sticking to these surfaces. As an example, if frame 40F or part of frame 40F is formed from stainless steel, coating 86 may be formed from an electroless nickel layer on the stainless steel. Some or all of the surfaces of groove 82 may also be provided with coatings such as coating 88. Coating 88 may be a thin adhesive layer, elastomeric polymer, or other coating material that tends to attract debris, thereby helping to prevent the debris from entering recess 54R. Coating 88 may be formed from multiple disposable layers. With this type of arrangement, a user can peel away and discard an outer layer of coating 88 to expose a fresh inner layer of coating 88.

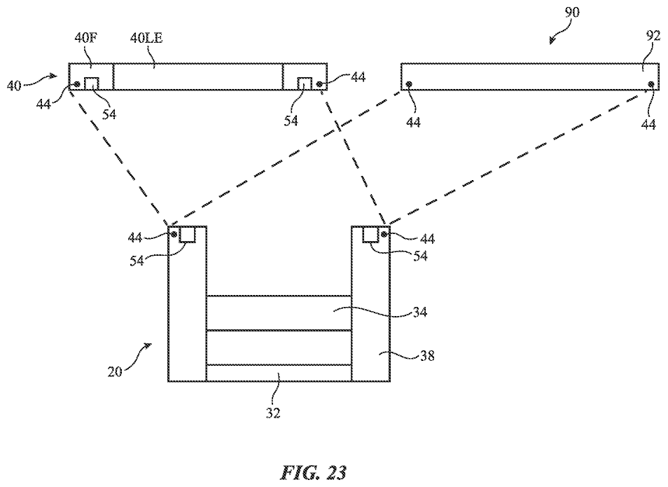

It may be desirable to provide device 10 with removable lens covers (sometimes referred to as lens caps). This type of arrangement is shown in FIG. 23. As shown in FIG. 23, each optical assembly 20 of device 10 may have magnets 44 that mate with corresponding magnets 44 in both removable vision correction lens 40 and removable lens cover 90. Lens 40 may have structures 54 that are configured to mate with corresponding structures 54 on assembly 20. Lens 40 may have a vision correction lens element 40LE that corrects for a user's vision errors (e.g., nearsightedness, etc.). When lens 40 is not in use, it may be desirable to cover and protect structures 54 on device 10 from debris. This may be accomplished using lens covers such as lens cover 90. Each lens cover 90 may have magnets 44 to removably couple cover 90 to assembly 20 and may optionally have structures 54 that are configured to mate with structures 54 of assembly 20. Lens covers such as lens cover 90 of FIG. 23 may be formed from cover members such as cover member 92. Cover member 92 may be formed from polymer (e.g., clear or opaque polymer), metal, and/or other materials.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device configured to operate with removable vision correction lenses, comprising:
a head-mounted housing; and
optical assemblies in the head-mounted housing, wherein each optical assembly has a fixed lens and a support for the fixed lens and is configured to couple to a respective one of the removable vision correction lenses, wherein each optical assembly has a respective display that is configured to display an image to a respective eye box through the fixed lens of that optical assembly and through the removable vision correction lens that is coupled to that optical assembly, and wherein each optical assembly and each removable vision correction lens coupled to that optical assembly are configured to form a kinematic coupling that aligns that optical assembly and that removable vision correction lens.

2. The head-mounted device defined in claim 1 wherein the kinematic coupling has at least one kinematic mount alignment recess.

3. The head-mounted device defined in claim 2 wherein the kinematic mount alignment recess has a debris cover.

4. The head-mounted device defined in claim 3 wherein the kinematic mount alignment recess is configured to mate with a corresponding kinematic mount alignment protrusion on the removable vision correction lens and wherein the debris cover comprises a wiper that is configured to: 1) when the kinematic mount alignment protrusion is out of the kinematic mount alignment recess, rest in a first position in which the wiper covers an opening to the kinematic mount alignment recess, and 2) when the kinematic mount alignment protrusion is in the kinematic mount alignment recess, move to a second position in which the wiper does not cover the opening of the kinematic mount alignment recess.

5. The head-mounted device defined in claim 3 wherein the debris cover comprises flexible polymer configured to bend when a kinematic mount alignment protrusion is received within the kinematic mount alignment recess.

6. The head-mounted device defined in claim 3 wherein the kinematic mount alignment recess comprises a V-shaped groove and wherein the debris cover comprises a wiper that is configured to bend when a kinematic mount alignment protrusion is placed in the V-shaped groove.

7. The head-mounted device defined in claim 2 further comprising a debris collection groove in communication with the kinematic mount alignment recess.

8. A removable vision correction lens configured to removably couple to an optical assembly in a head-mounted device that has a display and a fixed lens, the removable vision correction lens comprising:
a frame; and
a lens element in the frame, wherein the frame has a kinematic mount alignment recess that is configured to mate with a kinematic mount alignment protrusion in the optical assembly.

9. The removable vision correction lens defined in claim 8 wherein the kinematic mount alignment recess comprises a V-shaped groove in the frame and wherein the frame is configured to form a debris collection groove in communication with the V-shaped groove.

10. The removable vision correction lens defined in claim 9 wherein the debris collection groove is wider and deeper than the V-shaped groove.

11. The removable vision correction lens defined in claim 10 further comprising an adhesive coating in the debris collection groove.

12. The removable vision correction lens defined in claim 8 further comprising a magnet configured to attract debris away from the kinematic mount alignment recess.

13. The removable vision correction lens defined in claim 8 wherein the frame comprises a liquid drainage hole.

14. The removable vision correction lens defined in claim 8 further comprising a debris cover that is configured to cover the kinematic mount alignment recess when the removable vision correction lens is not coupled to the optical assembly.

15. A head-mounted device configured to operate with removable vision correction lenses, comprising:
a head-mounted housing; and
optical assemblies in the head-mounted housing, wherein each optical assembly is configured to receive a corresponding one of the removable vision correction lenses and wherein each optical assembly comprises:
a fixed lens;
a support for the fixed lens; and
a display, wherein the display is configured to provide images to an eye box through the fixed lens and the removable vision correction lens received by that optical assembly and wherein each optical assembly and corresponding removable vision correction lens is configured to form a kinematic coupling that aligns that optical assembly and that removable vision correction lens, the kinematic coupling including a plurality of kinematic mount alignment protrusions and a plurality of mating kinematic mount alignment recesses.

16. The head-mounted device defined in claim 15 wherein the supports of the optical assemblies are configured to form the kinematic mount alignment recesses.

17. The head-mounted device defined in claim 16 wherein the kinematic mount alignment recesses comprise grooves.

18. The head-mounted device defined in claim 17 further comprising flexible wipers that are configured to cover the grooves when the removable vision correction lenses are not coupled to the optical assemblies.

19. The head-mounted device defined in claim 15 wherein portions of the fixed lenses are configured to form the kinematic mount alignment recesses.

20. The head-mounted device defined in claim 15 wherein the optical assemblies comprise metal portions in which the kinematic mount alignment recesses are formed and wherein the metal portions are insert molded within the fixed lenses.
